(19) United States
(12) Patent Application Publication
(10) Pub. No.: US 2006/0233983 A1
(43) Pub. Date: Oct. 19, 2006

(54) Readily peelable cellulose-based sausage casing

(76) Inventors: Klaus-Dieter Blumenberg, Walsrode (DE); Heinrich Henze-Wethkamp, Walsrode (DE); Willi Neuschulz, Bad Fallingbostel (DE)

Correspondence Address: BAYER MATERIAL SCIENCE LLC, 100 BAYER ROAD, PITTSBURGH, PA, 15205, US

(21) Appl. No.: 11/401,428

(22) Filed: Apr. 10, 2006

(30) Foreign Application Priority Data
Apr. 13, 2005 (DE) 102005016 979.1

(51) Int. Cl. A22C 13/00

(52) U.S. Cl. 428/34.8; 138/118.1

(57) ABSTRACT

A tubular sausage casing based on cellulose hydrate and exhibits low adhesion to the filling is disclosed. The casing has a coating applied to its inside, the coating comprising a water-soluble polyvinyl alcohol and water-soluble cellulose ether. In an additional embodiment the coating further contains at least one member selected from the group consisting of oil and fatty diketene. A process for the preparation of the casing is also disclosed.

### FIELD OF THE INVENTION

The invention relates to a sausage casing and in particular to casing based on cellulose hydrate.

### BACKGROUND OF THE INVENTION

Sausage casings which, on their inside, have a coating for reducing the adhesion to the sausage have already been described.

For instance, EP 0374624 describes a tubular casing of regenerated cellulose which, on its inner surface, has a coating to improve the peelability, which coating consists of polyvinyl alcohol and a water-soluble carboxylic acid, preferably tartaric acid or citric acid.

EP 0180207 claims a coating composition which is used for treating the inner surface of non-fibrous food casings made of cellulose in order to improve peelability. The coating composition comprises a mixture of an anionic water-soluble cellulose ether such as carboxymethylcellulose and a nonionic water-soluble cellulose ether, and also, as third constituent, a lubricant. The lubricant is selected from the group consisting of mineral oil, vegetable oil, animal oil, silicone oil, acetylated monoglycerides, polyoxyethylene monoesters, sorbitan trioleate and mixtures thereof.

European patent EP 468 284 discloses non-fibrous food casings made of regenerated cellulose, which casings have coatings which improve the peelability of the casing from the encased food. The coating composition comprises a mixture of a water-soluble cellulose ether such as carboxymethylcellulose and a dextrin. Preferably, such a composition also contains lecithin and, to facilitate the production of self-sustaining shearable shirred sticks from the casing, preferably also an anti-pleat lock agent, e.g. an oil and also a surfactant.

The application DE 2 227 438 claims possibly fibre-reinforced tubular cellulose-based casings which are suitable for the stuffing and processing of foods. The casings, on the inside, have a coating of a homogeneous mixture of at least two components, one component consisting of a water-soluble cellulose ether and the second component consisting of an animal or vegetable oil, mineral oil, silicone oil and/or a water-soluble adduct of an alkylene oxide to a fatty acid partial ester.

The casing may be readily stripped off and detached from the foods processed therein.

European patent EP 0 109 611 describes tubular cellulose-based sausage casings which may be fibre-reinforced. On their inner surface they are given a coating to improve the peelability of the casing from the filling. The coating comprises a homogeneous mixture of at least two components, the first component consisting of a water-soluble cellulose ether and/or starch ether, and the second component consisting of a wax. As an additional third component, in addition, a non-reactive silicone oil can be present in the coating.

European patent EP 0 006 551 claims tubular casings based on cellulose hydrate which may be readily withdrawn from the filling, having a coating on the inside. The coating is a mixture of vegetable oils and/or triglyceride mixtures as first component, and chemically modified starch and/or partially saponified polyvinyl alcohol and/or microcrystalline cellulose as second component.

In the case of the above-mentioned cellulose-based sausage casings, the coatings for improving the peelability contain considerable fractions of water-soluble substances which substantially affect the ready detachability from the sausage mix.

Before being stuffed with the sausage emulsion, artificial skins made from cellulose hydrate are customarily soaked in order to make the casings sufficiently flexible and slippery for the stuffing operation. In this operation, the water-soluble fractions of the sausage casing are substantially dissolved and thus cannot improve the peelability.

The object was therefore to equip the inner coating of cellulose fibre skins in such a manner that the improved peelability of the casings is retained even after the soaking as under the specifications.

### SUMMARY OF THE INVENTION

A tubular sausage casing based on cellulose hydrate and exhibits low adhesion to the filling is disclosed. The casing has a coating applied to its inside, the coating comprising a water-soluble polyvinyl alcohol and water-soluble cellulose ether. In an additional embodiment the coating further contains at least one member selected from the group consisting of oil and fatty diketene. A process for the preparation of the casing is also disclosed.

### DETAILED DESCRIPTION OF THE INVENTION

Surprisingly, it has been found that the combination of a water-soluble cellulose ether such as carboxymethylcellulose with a water-soluble polyvinyl alcohol in the inner coating of such sausage casings synergistically causes good peelability from the sausage emulsion, whereas a coating of each of these substances alone cause a lesser improvement of the peelability.

Water soluble in the context of the invention means that the cellulose ether has a solubility in water at 25° C. of at least 5 g in 95 g water and the polyvinyl alcohol has a solubility in water at 90° C. of at least 10 g in 90 g water.

The invention therefore relates to a sausage casing based on preferably fibre-reinforced cellulose hydrate having a coating on the inside for ready peelability of the casing from the sausage. The coating comprise at least two constituents, the first constituent being a water-soluble polyvinyl alcohol preferably produced from polyvinyl acetate having a degree of saponification of at least 80%. The second constituent is a water-soluble cellulose ether, preferably carboxymethylcellulose.

It has been found that the synergistic effect of the reduced adhesion of the casing to the sausage is particularly pronounced when the percentage fraction of the water-soluble cellulose ether, in particular carboxymethylcellulose, based on the sum of the weight quantities of water-soluble cellulose ether and water-soluble polyvinyl alcohol in the coating, is more than 50%, in particular between 60 to 80%.

In a preferred embodiment, the coating, on the inside of the sausage casing, contains, as additional component, an oil and/or a fatty diketene as release agent for avoiding the laid-flat, wound up or shirred sausage casing from sticking together, and if appropriate, as antifoam during application of the coating to the sausage casing.

The oil is preferably a synthetic oil, particularly preferably a silicone oil, in particular preferably dimethyl polysiloxane. Such silicone oils are offered as emulsions commercially, for example by Wacker, according to the invention, in particular the silicone antifoam emulsion SILFOAM SE2 being used.

A suitable fatty diketene in the coating preferably contains long-chain fatty acids having 12 to 20 carbon atoms and, according to the invention, preference is given to the aqueous suspension Aquapel 7320 from Hercules, made anionic.

The sausage casing consists of a tube of regenerated cellulose which is preferably reinforced with a fibre fabric made from hemp fibres. Cellulose-based sausage casings which may be fibre-reinforced and have a coating for reducing the sausage emulsion adhesion are produced in a manner known per se. In this case the fibre fabric is formed to a tube, coated with viscose, regenerated, washed and treated with a glycerol as plasticizer.

The inventive coating on the inside of the regenerated cellulose casing is preferably applied before the drying.

In this case the aqueous impregnation solution is charged into the regenerated cellulose tube and uniformly applied to the inner surface using a pinch-roll pair through which the tube which is tightly inflated with supporting air is continuously passed in a horizontal or vertical running direction. The sausage casing is then dried, laid flat, and wound up to form rolls, the inventive casings not sticking together even under relatively long-term storage, and also that rewetting for subsequent final processing to give ready-to-stuff shirred tubing sticks may be carried out before the shirring operation, without the casings sticking together and only opening with difficulty for the shirring operation.

The coating has a weight per unit area of preferably 80 to 560 mg/m², particularly preferably 160 to 480 mg/m².

The invention further relates to a process for producing the inventive sausage casings.

The inventive process comprises applying to the sausage casing inner surface an aqueous solution containing in the range from 0.6 to 4.0% by weight of water-soluble polyvinyl alcohol and 0.1 to 4.0% by weight of water-soluble cellulose ether, the percentages by weight being based on the aqueous solution.

In a further embodiment, the aqueous solution contains, as additional constituent, an oil and/or a fatty diketene in the range from 0.1 to 2.0% by weight. The oil and/or fatty diketene is used in the form of an emulsion. Preference is given to the silicone antifoam emulsion ®SILFOAM SE2 to prevent excessive foaming of the impregnation solution on application.

In addition, emulsifiers may be added, preferably nonionic polyethylene glycol fatty alcohol ethers which are obtainable commercially as ®Brij types, to cause a uniform charging of the impregnation solution onto the cellulose surface.

The invention further relates to the use of the sausage casing for producing scalded-emulsion sausage, raw sausage, pepperoni and cooked ham.

### EXAMPLES

The invention will be described in more detail by the following examples. The figures of the substances represent the number of grammes of the active substances used in the impregnation solution.

The figure percentage fraction carboxymethylcellulose represents the percentage by weight of carboxymethylcellulose based on the sum of the weight fractions of carboxymethylcellulose and polyvinyl alcohol in the impregnation solution.

The carboxymethylcellulose was obtained from Wolff Cellulosics under the product designation ®Walocel CRT 30 GA and used as 5% strength by weight aqueous solution. The polyvinyl alcohol ®Mowiol type 28-99 from Clariant was used as 10% strength by weight aqueous solution. The commercial glycerol was diluted to 90% by weight with water. The antifoam emulsion ®Silfoam SE 2 from Wacker Silicones had an active content of 20% by weight and was diluted to 2% by weight for examples 1 to 8 and to 10% by weight for examples 9 to 17. The fatty diketene ®Aquapel 7320 from Hercules had an active compound content of 20% by weight and was used undiluted. The emulsifier polyoxyethylene-20-cetyl ether ®Brij 58 from ICI was used as 10% strength by weight aqueous solution. The sausage casings of the examples were produced in accordance with the above-described process, examples 1 to 8 in the nominal caliber 94 and examples 9 to 18 in the nominal caliber 55. The finished sausage casings were used to produce sausages of the scalded-emulsion type, the casings, before being stuffed with sausage emulsion, being soaked according to the specification for 30 minutes in hand-hot flowing water. After 2 days, their peelability was assessed. The sausage emulsion adhesion was rated on a scale of 0 to 5 of increasing adhesion of the sausage casing to the sausage.

### Examples 1-8

Examples 1-8 verify the synergistic effect in the large nominal caliber 94, in example 1, only the carboxymethylcellulose being contained, and in example 8, only the polyvinyl alcohol being contained and the sausage emulsion adhesion being greater in each case than in the mixtures of the two components, as may be seen, in particular, for examples 3 and 4.

| | | | | | | | | Substances in the impregnation |
|---|---|---|---|---|---|---|---|---|
| 1 | 2 | 3 | 4 | 5 | 6 | 7 | 8 | solution |
| 20 | 420 | 620 | 820 | 1020 | 1220 | 1620 | 2020 | Water |
| 4000 | 3200 | 2800 | 2400 | 2000 | 1600 | 800 | 0 | ® Walocel CRT 30 GA |
| 0 | 400 | 600 | 800 | 1000 | 1200 | 1600 | 2000 | ® Mowiol Type 28-99 |
| 880 | 880 | 880 | 880 | 880 | 880 | 880 | 880 | Glycerol |
| 100 | 100 | 100 | 100 | 100 | 100 | 100 | 100 | ® Silfoam SE 2 |
| 100 | 80 | 70 | 60 | 50 | 40 | 20 | 0 | Percentage fraction of |
| | | | | | | | | carboxymethylcellulose |
| 1.0 | 1.0 | 0.75 | 0.75 | 1.0 | 1.0 | 1.0 | 2.0 | Sausage emulsion adhesion |

### Examples 9-17

Examples 9 to 17 again show the synergistic effect in the smaller nominal caliber 55, where here an additional emulsifier and a higher content of the silicone oil emulsion were used. In example 9, only the carboxymethylcellulose is contained, and in example 17, only the polyvinyl alcohol is contained and the sausage emulsion adhesion is greater in each case than in the mixtures of the two components, as may be seen, in particular, for examples 11 to 14.

| | | | | | | | | | Substances in the |
|---|---|---|---|---|---|---|---|---|---|
| 9 | 10 | 11 | 12 | 13 | 14 | 15 | 16 | 17 | impregnation solution |
| 470 | 770 | 920 | 1070 | 1220 | 1370 | 1670 | 1920 | 1970 | Water |
| 3000 | 2400 | 2100 | 1800 | 1500 | 1200 | 600 | 100 | 0 | ® Walocel CRT 30 GA |
| 150 | 150 | 150 | 150 | 150 | 150 | 150 | 150 | 150 | ® Brij 58 |
| 0 | 300 | 450 | 600 | 750 | 900 | 1200 | 1450 | 1500 | ® Mowiol Type 28-99 |
| 880 | 880 | 880 | 880 | 880 | 880 | 880 | 880 | 880 | Glycerol |
| 500 | 500 | 500 | 500 | 500 | 500 | 500 | 500 | 500 | ® Silfoam SE 2 |
| 100 | 80 | 70 | 60 | 50 | 40 | 20 | 3.3 | 0 | Percentage fraction of |
| | | | | | | | | | carboxymethylcellulose |
| 1.5 | 1.0 | 0.75 | 0.75 | 0.75 | 0.6 | 1.0 | 1.25 | 1.75 | Sausage emulsion |
| | | | | | | | | | adhesion |

### Example 18

In this example, the release agent ®Aquapel 7320 was used.

| | Substances in the impregnation |
|---|---|
| 18 | solution |
| 2170 | Water |
| 100 | ® Walocel CRT 30 GA |
| 150 | ® Brij 58 |
| 1450 | ® Mowiol Type 28-99 |
| 880 | Glycerol |
| 250 | ® Aquapel 7320 |
| 3.3 | Percentage fraction of |
| | carboxymethylcellulose |
| 1.5 | Sausage emulsion adhesion |

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. A tubular sausage casing based on cellulose hydrate having a coating on its inside, the coating comprising a water-soluble polyvinyl alcohol and water-soluble cellulose ether.

2. The sausage casing according to claim 1, wherein coating further comprise at least one member selected from the group consisting of oil and fatty diketene.

3. The sausage casing according to claim 1, wherein the water-soluble polyvinyl alcohol is a polyvinyl acetate having a degree of saponification of at least 80%.

4. The sausage casing according to claim 1, wherein the water-soluble cellulose ether is carboxymethylcellulose.

5. The sausage casing according to claim 1, wherein cellulose ether is present in the coating in an amount greater than 50% relative to the total weight of cellulose ether and polyvinyl alcohol.

6. The sausage casing according to claim 2, wherein the oil is a fully synthetic oil.

7. The sausage casing according to claim 2, wherein the fatty diketene contains long-chain (C₁₂-C₂₀) fatty acids.

8. The sausage casing according to claim 6, wherein synthetic oil is silicone oil.

9. The sausage casing according to claim 1, wherein the coating has a weight per unit area of 80 to 560 mg/m².

10. The sausage casing according to claim 1, characterized in that it is fiber reinforced.

11. A process for producing the sausage casings according to claim 1, comprising applying to the inside of a tube based on cellulose hydrate, an aqueous solution which contains 0.6 to 4.0% by weight of polyvinyl alcohol and 0.1 to 4.0% by weight of carboxymethylcellulose.

12. The process according to claim 11, wherein the aqueous solution further contains 0.1 to 2.0% relative to the weight of the solution at least one member selected from the group consisting of oil and fatty diketene.

13. The process according to claim 11, wherein the aqueous solution further contains at least one emulsifier.
